(19) United States
(12) Patent Application Publication
(10) Pub. No.: US 2020/0335901 A1
(43) Pub. Date: Oct. 22, 2020

(54) CONNECTOR

(71) Applicants: AUTONETWORKS TECHNOLOGIES, LTD., Yokkaichi-shi, Mie (JP); SUMITOMO WIRING SYSTEMS, LIMITED, Yokkaichi-shi, Mie (JP); SUMITOMO ELECTRIC INDUSTRIES, LTD., Osaka-shi, Osaka (JP)

(72) Inventors: Yusuke YAMADA, Yokkaichi-shi (JP); Hirotaka BABA, Yokkaichi-shi (JP); Junichi MUKUNO, Yokkaichi-shi (JP)

(73) Assignees: AUTONETWORKS TECHNOLOGIES, LTD., Yokkaichi-shi, Mie (JP); SUMITOMO WIRING SYSTEMS, LIMITED, Yokkaichi-shi, Mie (JP); SUMITOMO ELECTRIC INDUSTRIES, LTD., Osaka-shi, Osaka (JP)

(21) Appl. No.: 16/959,271

(22) PCT Filed: Jan. 15, 2019
(86) PCT No.: PCT/JP2019/000848

§ 371 Date: Jun. 30, 2020

(30) Foreign Application Priority Data
Jan. 16, 2018 (JP) 2018-004904

(51) Int. Cl. H01R 13/52; H01R 9/18

(52) U.S. Cl. CPC H01R 13/5208; H01R 9/11; H01R 13/5205; H01R 9/18

(57) ABSTRACT

A connector that includes a wire; a housing having a wire draw-out surface, the wire being drawn out rearward from the wire draw-out surface; a shield provided with a peripheral wall extending rearward from an outer peripheral position of the wire draw-out surface and a rear wall extending in a diameter reducing direction from a rear end of the peripheral wall; and a water stop having a housing sealing surface and a wire sealing surface provided to intersect each other, the rear wall of the shield contacting the water stop to bring the housing sealing surface into contact with the wire draw-out surface, the peripheral wall of the shield directly contacting the water stop to bring the wire sealing surface into contact with the wire.

### BACKGROUND

A technique disclosed in this specification relates to a connector.

Conventionally, a connector with a housing having a waterproof structure is, for example, known from Japanese Unexamined Patent Publication No. 2017-157417. This waterproof connector is composed of a housing, a rubber plug and a shield shell. The housing includes a wire inserting portion through which a wire is inserted, and a rubber plug accommodating portion is provided in the rear end of the wire inserting portion. A rubber plug is accommodated in the rubber plug accommodating portion, an inner peripheral lip thereof is held in close contact with the outer peripheral surface of the wire over the entire circumference and an outer peripheral lip thereof is held in close contact with the inner peripheral surface of the rubber plug accommodating portion over the entire circumference. A tubular shell body of the shield shell covers the outer peripheral surface of the wire inserting portion and is arranged such that a rear wall thereof faces the rear end surface of the wire inserting portion. The inner and outer peripheral lips of the rubber plug are further compressed in a radial direction by the rear wall pressing the rubber plug from behind and compressing the rubber plug in a front-rear direction.

### SUMMARY

However, since the rubber plug is accommodated in the rubber plug accommodating portion of the housing and the outer periphery of the rubber plug accommodating portion is covered with the shell body of the shield shell in this technique, the connector is enlarged.

A connector according to the technique disclosed in this specification includes a wire, a housing having a wire draw-out surface, the wire being drawn out rearward from the wire draw-out surface, a shield provided with a peripheral wall extending rearward from an outer peripheral position of the wire draw-out surface and a rear wall extending in a diameter reducing direction from a rear end of the peripheral wall, and a water stop having a housing sealing surface and a wire sealing surface provided to intersect each other, the rear wall of the shield contacting the water stop to bring the housing sealing surface into contact with the wire draw-out surface, the peripheral wall of the shield directly contacting the water stop to bring the wire sealing surface into contact with the wire.

According to this configuration, since the housing sealing surface of the water stop contacts the wire draw-out surface and the wire sealing surface provided to intersect the housing sealing surface contacts the wire drawn out from the wire draw-out surface, the intrusion of water and the like into the housing from the wire draw-out surface can be prevented.

Further, since the rear wall and the peripheral wall of the shield contact the water stop, another member for holding the water stop in close contact with the wire draw-out surface and the wire is unnecessary. In this way, the connector can be reduced in size.

The following configurations are preferable as embodiments according to the technique disclosed in this specification.

(1) The wire includes a plurality of e wires that are drawn out from the wire draw-out surface, the water stop includes a through hole group composed of a plurality of through holes having wire sealing surfaces on hole walls, one wire of the plurality of wires being press-fit into each of the plurality of through holes, and the rear wall of the shield includes a surrounding contact disposed to collectively surround the plurality of wires and held in contact with a part of the water stop around the through hole group and an inter-wire contact portion disposed between respective wires of the plurality of wires and held in contact with a part of the water stop between the plurality of through holes.

In a configuration in which the surrounding contact contacts the part of the water stop around the through hole group, there is a concern that the part between the plurality of through holes is deformed to escape and a clearance is formed between the wire and the water stop. According to the above configuration, since the inter-wire contact portion contacts the part of the water stop between the plurality of through holes, the formation of the clearance between the wire and the water stop due to the deformation of the water stop can be prevented.

(2) The wire and the housing are integrally formed by insert molding.

If the wire and the housing are integrally formed by insert molding, a clearance between the wire and the housing allows the intrusion of water and the like. Since the wire sealing surface and the housing sealing surface are provided to intersect each other according to the above configuration, the intrusion of water and the like into the housing can be prevented.

The connector according to the technique disclosed in this specification can be reduced in size by suppressing the number of components while preventing water intrusion into the housing.

### BRIEF DESCRIPTION OF THE DRAWINGS

FIG. 1 is a longitudinal section of a connector according to an embodiment,

FIG. 2 is an exploded perspective view of the connector viewed from behind, and

FIG. 3 is an exploded longitudinal section of the connector.

### DETAILED DESCRIPTION OF EMBODIMENTS

### Embodiment

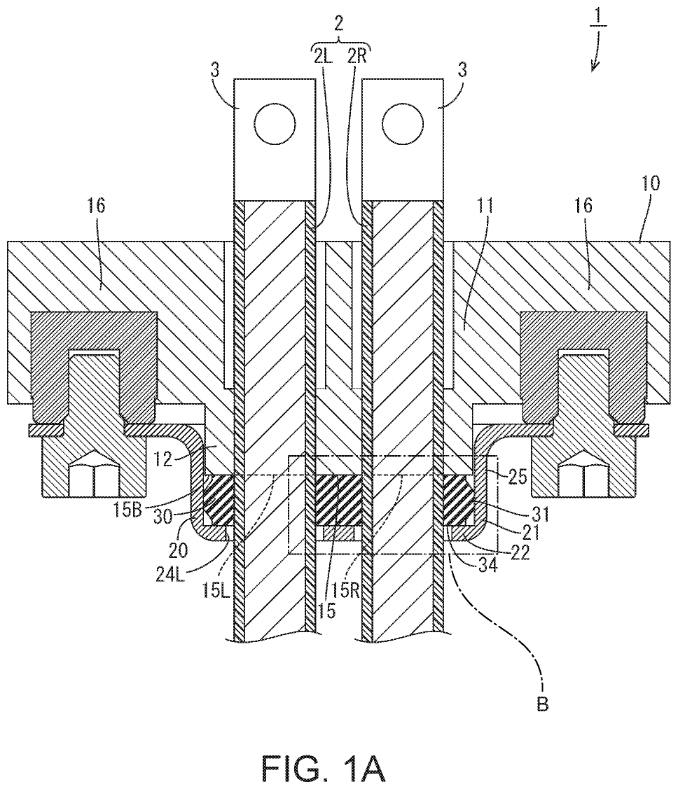

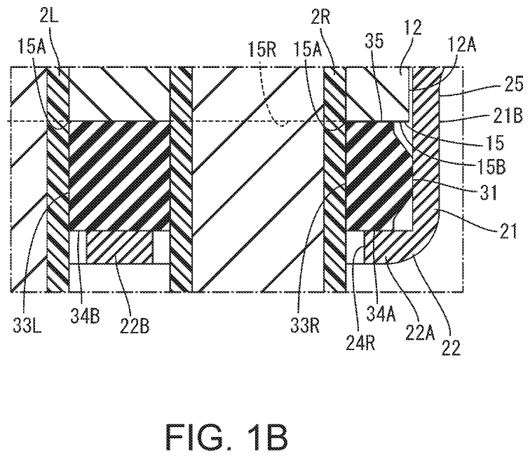

An embodiment is described with reference to FIGS. 1 to 3.

As shown in FIG. 1(A), a connector 1 of this embodiment is a waterproof connector mounted on one end of each of two wires 2L, 2R constituting a harness and used by being connected to an unillustrated device such as an inverter. As shown in FIG. 1, the connector 1 includes a housing 10, a shield bracket 20 (an example of a shield member/shield) and a water stop member 30 (water stop). The wires 2L, 2R are disposed inside the housing 10 by insert molding, and a terminal fitting 3 to be connected to a device side is mounted on the one end of each of the wires 2L, 2R, and the other ends of the wires 2L, 2R are drawn out from a side where the shield bracket 20 is disposed. In the following description, the wires 2L, 2R may be referred to as wires 2. Further, a side where the terminal fittings 3 are connected to the wires 2 is referred to as a front side and a side where the wires 2 are drawn out from the housing 10 is referred to as a rear side below.

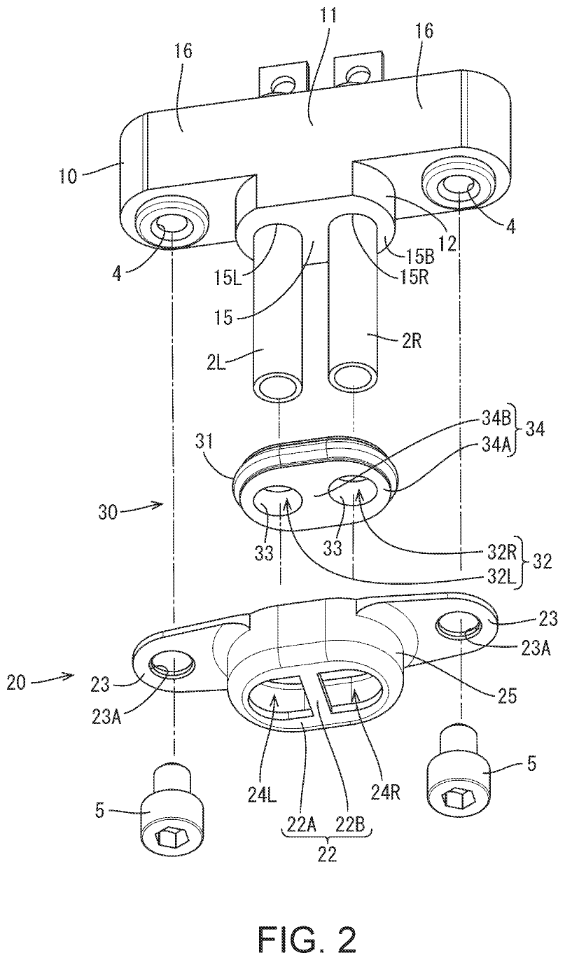

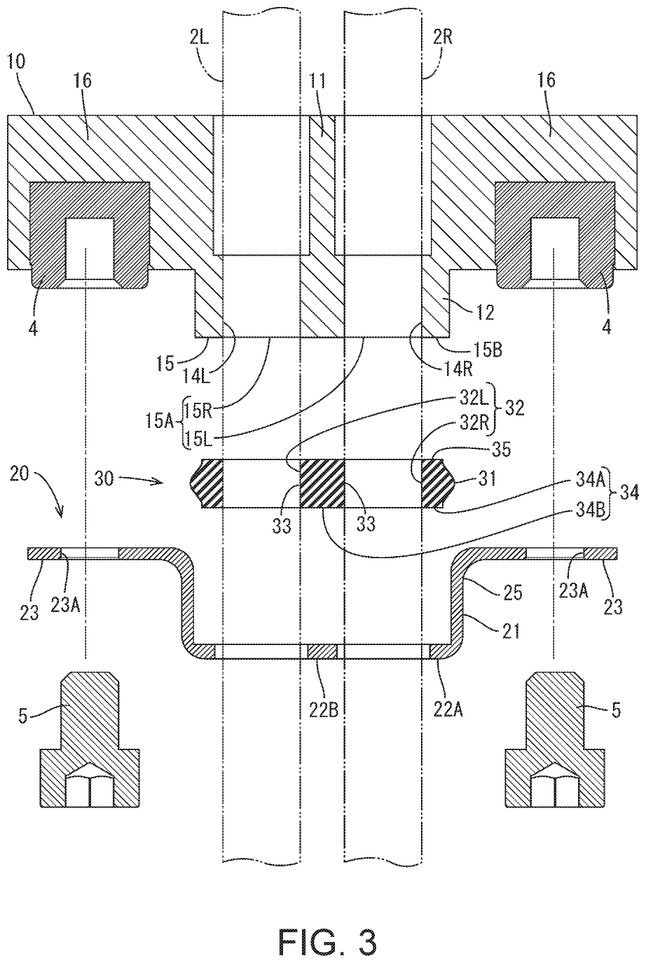

As shown in FIG. 2, the housing 10 includes a wire inserting portion 11 and a pair of mounting receiving portions 16 laterally projecting from the wire inserting portion 11. As shown in FIG. 3, a nut 4 is so embedded in each of the pair of mounting receiving portions 16 by insert molding as to be open rearward.

The wire inserting portion 11 is shaped to project further rearward than the mounting receiving portions 16, and this projecting part serves as a wire draw-out portion 12. The wire draw-out portion 12 has an elliptical shape when viewed from behind as shown in FIG. 2.

As shown in FIG. 3, the wire draw-out portion 12 is formed with two wire draw-out holes 14L, 14R, into each of which one of the wires 2L, 2R is insertable. Each wire draw-out hole 14L, 14R is a circular hole and extends in a front-rear direction in the wire inserting portion 11. The rear end of the wire draw-out portion 12 serves as a wire draw-out surface 15 in which the wire draw-out holes 14L, 14R are open. The wire draw-out surface 15 is a flat surface orthogonal to the wire draw-out holes 14L, 14R. As indicated by imaginary lines in FIG. 3, the wires 2L, 2R are respectively inserted into the wire draw-out holes 14L, 14R and drawn out rearward from the wire draw-out surface 15. Openings of the wire draw-out holes 14L, 14R in the wire draw-out surface 15 are referred to as draw-out openings 15L, 15R, and the draw-out openings 15L, 15R are collectively referred to as a draw-out opening group 15A. Further, a region around the draw-out opening group 15A is referred to as a draw-out surrounding portion 15B.

The shield bracket 20 is a member made of a metal material and configured to cover and shield the wire draw-out portion 12 of the housing 10. As shown in FIG. 2, the shield bracket 20 is composed of a surrounding wall 25, a rear wall 22 and mounting portions 23.

As shown in FIGS. 2 and 3, the surrounding wall 25 is a hollow tubular body having an elliptical shape when viewed from behind. The surrounding wall 25 is longer in a front-rear direction than the wire draw-out portion 12 and surrounds the wire draw-out portion 12 and projects further rearward than the wire draw-out surface 15 with the shield bracket 20 mounted on the housing 10 as shown in FIG. 1. A part of the surrounding wall 25 projecting further rearward than an outer peripheral position of the wire draw-out surface 15 is referred to as a peripheral wall 21 below. A front end position 21B of the peripheral wall 21 and the draw-out openings 15L, 15R of the wire draw-out surface 15 are at the same position in the front-rear direction as shown in FIG. 1(B).

As shown in FIG. 2, the rear wall 22 is provided on the rear end of the peripheral wall 21. The rear wall 22 includes a frame-shaped surrounding contact portion 22A (surrounding contact) extending in a diameter reducing direction from the rear end of the peripheral wall 21 and an inter-wire contact portion 22B provided along a lateral center line of the surrounding contact portion 22A. In other words, the surrounding contact portion 22A and the inter-wire contact portion 22B form two holding openings 24L, 24R.

As shown in FIG. 2, the mounting portions 23 are shaped to extend leftward and rightward from the front end of the peripheral wall 21. One mounting hole 23A is provided to penetrate through each mounting portion 23 in the front-rear direction.

The water stop member 30 is made of resiliently deformable synthetic resin and, as shown in FIG. 2, in the form of an elliptical plate corresponding to the wire draw-out surface 15 when viewed from behind. A plate thickness of the water stop member 30 is slightly larger than an inner dimension of the peripheral wall 21 of the shield bracket 20 in the front-rear direction. As shown in FIG. 3, a housing sealing surface 35 and a rear surface 34 provided on the front surface of the water stop member 30 are flat surfaces.

The water stop member 30 is formed with a through hole group 32 composed of two circular through holes 32L, 32R penetrating from the housing sealing surface 35 to the rear surface 34. Hole walls of the respective through holes 32L, 32R serve as wire sealing surfaces 33L, 33R to be held in contact with the respective wires 2L, 2R. The wire sealing surfaces 33L, 33R and the housing sealing surface 35 are orthogonal to each other. As shown in FIG. 2, a region of the rear surface 34 collectively surrounding the two through holes 32L, 32R is referred to as a collective surrounding portion 34A and a part thereof between the through holes 32L, 32R is referred to as an inter-wire portion 34B below.

One outer peripheral rib 31 is formed to project in a diameter expanding direction over the entire circumference on the outer peripheral surface of the water stop member 30. An outer diameter of the outer peripheral rib 31 is slightly larger than an inner diameter of the peripheral wall 21 of the shield bracket 20.

The shield bracket 20 is mounted on the housing 10 as shown in FIG. 1(A) by inserting bolts 5 into the respective mounting holes 23A and threadably engaging the bolts 5 with the nuts 4 as shown in FIG. 2. In this state, as shown in FIG. 1(B), the surrounding wall 25 covers an outer peripheral surface 12A of the wire draw-out portion 12 across a clearance defined between the outer peripheral surface 12A and the surrounding wall 25. The peripheral wall 21 is disposed to extend further rearward than the wire draw-out surface 15 as described above and the rear wall 22 is disposed on the rear end of the peripheral wall 21 across a clearance defined between the wire draw-out surface 15 of the housing 10 and the rear wall 22. The water stop member 30 is accommodated in the clearance between the wire draw-out surface 15 and the rear wall 22 and surrounded by the peripheral wall 21. The wires 2L, 2R drawn out from the wire draw-out surface 15 respectively extend rearward through the through holes 32L, 32R of the water stop member 30 and the holding openings 24L, 24R of the shield bracket 20.

In this state, the wire sealing surfaces 33 of the water stop member 30 are in contact with the respective wires 2L, 2R over the entire circumference and the outer peripheral rib 31 is in contact with the peripheral wall 21 over the entire circumference as shown in FIG. 1(B). The housing sealing surface 35 of the water stop member 30 is directly in contact with the draw-out surrounding portion 15B of the wire draw-out surface 15 over the entire circumference and the rear surface 34 is directly in contact with the rear wall 22 of the shield bracket 20. More particularly, out of the rear wall 22 of the shield bracket 20, the surrounding contact portion 22A is directly in contact with the collective surrounding portion 34A and the inter-wire contact portion 22B is directly in contact with the inter-wire portion 34B. In this way, the draw-out opening group 15A of the wire draw-out holes 14L, 14R is accommodated within a water stop region isolated from water and the like outside.

Next, an assembling procedure of the connector 1 is illustrated.

First, as shown in FIG. 2, the wires 2L, 2R insert-molded in the housing 10 and drawn out from the wire draw-out surface 15 are respectively press-fit into the through holes 32L, 32R of the water stop member 30. Subsequently, after the wires 2L, 2R drawn out from the rear surface 34 of the water stop member 30 are respectively inserted through the holding openings 24L, 24R of the shield bracket 20, the bolts 5 are inserted through the mounting holes 23A and threadably engaged with the nuts 4.

Then, as the bolts 5 are threadably engaged, the rear wall 22 of the shield bracket 20 comes into contact with the rear surface 34 of the water stop member 30 to press the water stop member 30 toward the wire draw-out surface 15. Threadable engagement is completed when the housing sealing surface 35 comes into surface contact with the wire draw-out surface 15, thereby completing the connector 1 in which the water stop member 30 is accommodated in a space defined by the wire draw-out surface 15 of the housing 10 and the shield bracket 20 as shown in FIG. 1(A). At this time, as the two bolts 5, 5 are laterally equally threadably engaged with the respective nuts 4, 4, the surrounding contact portion 22A comes into contact with the collective surrounding portion 34A of the water stop member 30 equally over the entire circumference and the inter-wire contact portion 22B comes into contact with the inter-wire portion 34B equally over both ends.

By the above configuration, the connector 1 of this embodiment includes the wires 2, the housing 10 having the wire draw-out surface 15, the wires 2 being drawn out rearward from the wire draw-out surface 15, the shield member (shield bracket 20) provided with the peripheral wall 21 extending rearward from the outer peripheral position of the wire draw-out surface 15 and the rear wall 22 extending in the diameter reducing direction from the rear end of the peripheral wall 21, and the water stop member 30 having the housing sealing surface 35 and the wire sealing surfaces 33 provided to intersect each other, the rear wall 22 of the shield member 20 contacts the water stop member 30 to bring the housing sealing surface 35 into contact with the wire draw-out surface 15, and the peripheral wall 21 of the shield member 20 directly contacts the water stop member 30 to bring the wire sealing surfaces 33 into contact with the wires 2.

According to this configuration, since the housing sealing surface 35 of the water stop member 30 contacts the wire draw-out surface 15 and the wire sealing surfaces 33 provided to intersect the housing sealing surface 35 contact the wires 2 drawn out from the wire draw-out surface 15, the intrusion of water and the like into the housing 10 from the wire draw-out surface 15 can be prevented.

Further, since the rear wall 22 and the peripheral wall 21 of the shield member 20 contact the water stop member 30, another member for holding the water stop member 30 in close contact with the wire draw-out surface 15 and the wires 2 is unnecessary. In this way, the connector 1 can be reduced in size.

Further, the plurality of wires 2 are drawn out from the wire draw-out surface 15, the water stop member 30 includes the through hole group 32 composed of the plurality of through holes 32L, 32R having the wire sealing surfaces 33 on the hole walls, one of the plurality of wires 2 being press-fit into each of the plurality of through holes 32L, 32R, and the rear wall 22 of the shield member 22 includes the surrounding contact portion 22A disposed to collectively surround the plurality of wires 2 and held in contact with the part of the water stop member 30 around the through hole group 32 and the inter-wire contact portion 22B disposed between the plurality of wires 2 and held in contact with the part of the water stop member 30 between the plurality of through holes 32L, 32R.

In a configuration in which the surrounding contact portion contacts the part of the water stop member 30 around the through hole group 32, there is a concern that the part between the plurality of through holes 32L, 32R is deformed to escape and clearances are formed between the wires 2 and the water stop member 30. According to the above configuration, since the inter-wire contact portion 22B contacts the part of the water stop member 30 between the plurality of through holes 32L, 32R, the formation of the clearances between the wires 2 and the water stop member 30 due to the deformation of the water stop member 30 can be prevented.

Further, the wires 2 and the housing 10 are integrally formed by insert molding.

If the wires 2 and the housing 10 are integrally formed by insert molding, clearances between the wires 2 and the housing 10 allow the intrusion of water and the like. Since the wire sealing surfaces 33 and the housing sealing surface 35 are provided to intersect each other according to the above configuration, the intrusion of water and the like into the housing 10 can be prevented.

### Other Embodiments

The technique disclosed in this specification is not limited to the above described and illustrated embodiment and can be, for example, embodied as follows.

(1) Although the plurality of wires 2L, 2R are drawn out from the wire draw-out surface 15 in the above embodiment, the number of the wires is not limited to this and only one or three or more wires may be drawn out.

(2) Although the water stop member 30 and the rear wall 22 are disposed to face each other in the above embodiment, a water stop member and a rear wall may not necessarily face each other. For example, another member may be disposed between the rear wall and the water stop member.

(3) Although the shield bracket 20 is fixed to the housing 10 in the above embodiment, a fixing destination of a shield bracket is not limited to this. For example, the shield bracket may be fixed to a casing of a device on which a connector is mounted.

(4) Although the wires 2 are disposed in the housing 10 by insert molding in the above embodiment, a wire inserting portion may be provided with wire insertion holes in advance and wires may be inserted into these wire insertion holes.

(5) Although the wire draw-out portion 12 of the housing 10 is shaped to project rearward in the above embodiment, the shape of a wire draw-out portion is not limited to this. For example, a wire draw-out surface may be provided to be flush with the rear surfaces of mounting receiving portions. In that case, a peripheral wall of a shield member may be, for example, in form of a flat surface extending along the rear surfaces of the mounting receiving portions from the outer periphery of the wire draw-out surface.

(6) Although the housing sealing surface 35 of the water stop member 30 is a flat surface in the above embodiment, a housing sealing surface may not necessarily be flat. For example, a contact rib projecting forward to collectively surround a through hole group may be provided on a housing sealing surface. In this case, a contact pressure can be more reliably obtained and water stop performance can be improved by the contact of the contact rib with a wire draw-out surface.

1. A connector, comprising:
a wire;
a housing having a wire draw-out surface, the wire being drawn out rearward from the wire draw-out surface;
a shield provided with a peripheral wall extending rearward from an outer peripheral position of the wire draw-out surface and a rear wall extending in a diameter reducing direction from a rear end of the peripheral wall; and
a water stop having a housing sealing surface and a wire sealing surface provided to intersect each other,
the rear wall of the shield contacting the water stop to bring the housing sealing surface into contact with the wire draw-out surface, the peripheral wall of the shield directly contacting the water stop to bring the wire sealing surface into contact with the wire.

2. The connector of claim 1, wherein:
the wire includes a plurality that are drawn out from the wire draw-out surface,
the water stop includes a through hole group composed of a plurality of through holes having wire sealing surfaces on hole walls, one wire of the plurality of wires being press-fit into each of the plurality of through holes, and
the rear wall of the shield includes a surrounding contact disposed to collectively surround the plurality of wires and held in contact with a part of the water stop around the through hole group and an inter-wire contact disposed between respective wires of the plurality of wires and held in contact with a part of the water stop between the plurality of through holes.

3. The connector of claim 1, wherein the wire and the housing are integrally formed by insert molding.
